(19) United States
(12) Patent Application Publication
(10) Pub. No.: US 2025/0091166 A1
(43) Pub. Date: Mar. 20, 2025

(54) AUTOMATIC SUPPLY SYSTEM OF A TERMINAL ASSEMBLY FOR A STATOR

(71) Applicants: HYUNDAI MOTOR COMPANY, Seoul (KR); KIA CORPORATION, Seoul (KR)

(72) Inventors: Byeong Geon Kim, Hwaseong-si (KR); Woo Hyun An, Hwaseong-si (KR); Seohee Han, Hwaseong-si (KR)

(73) Assignees: HYUNDAI MOTOR COMPANY, Seoul (KR); KIA CORPORATION, Seoul (KR)

(21) Appl. No.: 18/766,780

(22) Filed: Jul. 9, 2024

(30) Foreign Application Priority Data
Sep. 18, 2023 (KR) 10-2023-0123682

(51) Int. Cl. B23K 37/04; H02K 15/00

(52) U.S. Cl. CPC B23K 37/04; H02K 15/33

(57) ABSTRACT

An automatic supply system of a terminal assembly for a hair pin type stator supplies the terminal assembly to a welding unit welding the stator coil and terminal assembly of the hair pin type stator to each other. The system includes: i) a conveyor unit transporting a terminal supply box storing the plurality of terminal assemblies along a set transport path; ii) a terminal supply robot gripping or releasing at least one terminal assembly of the plurality of terminal assemblies, and loading or unloading the at least one terminal assembly at a set location; and iii) a terminal alignment unit aligning the at least one terminal assembly loaded at the set location by the terminal supply robot.

### CROSS-REFERENCE TO RELATED APPLICATION

This application claims priority to and the benefit of Korean Patent Application No. 10-2023-0123682 filed in the Korean Intellectual Property Office on Sep. 18, 2023, the entire contents of which are incorporated herein by reference.

### BACKGROUND

### (a) Technical Field

The present disclosure relates to drive motor manufacturing equipment, and more particularly, to an automatic supply system of a terminal assembly for a stator.

### (b) Related Art

In general, a hybrid vehicle or an electric automobile, which is referred to as an eco-friendly automobile, uses technology for generating a drive force by a drive motor.

An automaker and an eco-friendly part manufacturer use the drive motor having a stator wound with a hair pin type stator coil as a part of efforts to reduce the weight and volume of the vehicle or a vehicle part.

This hair pin type stator may be manufactured in a process of inserting the hair pin type stator coil into a slot of a stator core and welding an end of the stator coil.

In the above manufacturing process, a three-phase or four-phase coil outlet drawn from the stator coil may be connected to a terminal assembly by welding.

In this terminal assembly welding process, when the stator is input into welding equipment, a worker may supply the terminal assembly to the welding equipment by using a separate jig.

Therefore, the worker may manually supply the terminal assembly, thus having lower welding workability and consuming an excessive welding work time.

Furthermore, when the worker manually supplies the terminal assemblies of different specifications to the plurality of welding equipment, the number of workers may be increased, and the worker may supply the terminal assembly of a specification not matching a stator model to the welding equipment.

The above information disclosed in this Background section is provided only to assist in understanding of the background of the present disclosure, and may thus include information not included in the prior art already known to those having ordinary skill in the art to which the present disclosure pertains.

### SUMMARY

The present disclosure provides an automatic supply system of a terminal assembly for a hair pin type stator that may automatically supply terminal assemblies of different specifications to a welding unit.

According to an embodiment, an automatic supply system of a terminal assembly for a hair pin type stator supplies the terminal assembly to a welding unit welding the stator coil and terminal assembly of the hair pin type stator to each other. The system includes: i) a conveyor unit transporting a terminal supply box storing the plurality of terminal assemblies along a set transport path; ii) a terminal supply robot gripping or ungripping (i.e., releasing) at least one terminal assembly of the plurality of the terminal assemblies, and loading or unloading the at least one terminal assembly at a set location; and iii) a terminal alignment unit (i.e., a terminal adjustment unit) aligning the at least one terminal assembly (e.g., adjusting at least one of the position, direction, angle, or any combination of them of the at least one terminal assembly) loaded at the set location by the terminal supply robot.

The terminal supply robot may unload the at least one terminal assembly stored in the terminal supply box, and load the at least one terminal assembly into the terminal alignment unit.

The terminal supply robot may unload the at least one terminal assembly aligned by the terminal alignment unit from the terminal alignment unit, and load the at least one terminal assembly into a welding jig of the welding unit.

The terminal supply robot may load the at least one terminal assembly into each of a plurality of welding jigs of the welding units that are disposed within an operation radius.

The conveyor unit may include at least one conveyor body including a plurality of conveyor rollers rotatably installed along the set transport path.

The conveyor unit may further include a tilting module installed on the set transport path of the conveyor body.

The tilting module may include a tilting plate installed at a location corresponding to an end of the set transport path to be able to be tilted and rotated with respect to the conveyor body in a vertical direction, and a tilt cylinder installed on the conveyor body and connected to the tilting plate.

The tilting plate may include a stopper stopping the transportation of the terminal supply box.

The terminal supply robot may include at least one gripper mounted on a tip of an arm through a mounting bracket.

The terminal supply robot may further include a vision sensor installed on the mounting bracket to capture a vision of the at least one terminal assembly of the plurality of the remaining assemblies stored in the terminal supply box and outputting vision data to a controller.

The controller may acquire location information of the at least one terminal assembly by comparing the vision data with set reference data.

The terminal alignment unit may include a support frame, a terminal locator installed on the support frame to support the at least one terminal assembly, terminal alignment members installed to be able to be moved forward and backward from both sides of the terminal locator while having the terminal locator therebetween, and an alignment cylinder installed on the support frame and connected to the terminal alignment member.

The terminal locator may have a ring shape to support the at least one terminal assembly having a semicircular shape.

The terminal alignment member may have an arc shape to support the at least one terminal assembly.

The terminal supply box may include terminal storage sections respectively partitioned by a plurality of partitions.

As set forth above, the automatic supply system of a terminal assembly for a hair pin type stator according to an embodiment of the present disclosure may automatically supply the terminal assemblies to the welding unit, thereby improving the welding workability of the terminal assembly, and reducing the excessive welding work time and the number of workers.

Another effect which may be acquired or predicted by an embodiment of the present disclosure is disclosed directly or implicitly in the detailed description of an embodiment of the present disclosure. In other words, various effects predicted from an embodiment of the present disclosure are disclosed in the detailed description described below.

### BRIEF DESCRIPTION OF THE DRAWINGS

The drawings are provided only for reference to describe an embodiment of the present disclosure. Accordingly, the spirit of the present disclosure should not be construed as being limited to the accompanying drawings.

FIG. 1 is a block diagram schematically showing an automatic supply system of a terminal assembly for a hair pin type stator according to an embodiment of the present disclosure.

FIG. 2 is a view schematically showing the hair pin type stator applied to the automatic supply system of a terminal assembly for a hair pin type stator according to an embodiment of the present disclosure.

FIG. 3 is a perspective view showing a conveyor unit applied to the automatic supply system of a terminal assembly for a hair pin type stator according to an embodiment of the present disclosure.

FIG. 4 is a plan view showing the conveyor unit applied to the automatic supply system of a terminal assembly for a hair pin type stator according to an embodiment of the present disclosure.

FIG. 5 is a side view showing the conveyor unit applied to the automatic supply system of a terminal assembly for a hair pin type stator according to an embodiment of the present disclosure.

FIG. 6 is a perspective view showing a terminal supply robot applied to the automatic supply system of a terminal assembly for a hair pin type stator according to an embodiment of the present disclosure.

FIG. 7 is a perspective view showing a portion of a gripper of the terminal supply robot applied to the automatic supply system of a terminal assembly for a hair pin type stator according to an embodiment of the present disclosure.

FIG. 8 is a perspective view showing a terminal alignment unit applied to the automatic supply system of a terminal assembly for a hair pin type stator according to an embodiment of the present disclosure.

It should be understood that the drawings referenced above are not necessarily drawn to scale, and present a rather simplified representation of various example features showing the basic principles of the present disclosure. For example, specific design features of the present disclosure, including a specific dimension, orientation, position and shape, are determined in part by the particular intended application and environment of use.

### DETAILED DESCRIPTION

Hereinbelow, an embodiment of the present disclosure is described in detail with reference to the accompanying drawings for those having ordinary skill in the art to which the present disclosure pertains to easily practice the present disclosure. However, the present disclosure may be modified in various different forms, and is not limited to an embodiment described in the specification.

A portion unrelated to the description is omitted in order to concisely describe the present disclosure, and the same or similar components are denoted by the same reference numeral throughout the specification.

In addition, the size and thickness of each component shown in the accompanying drawings are arbitrarily provided for convenience of explanation. Therefore, the present disclosure is not necessarily limited to contents shown in the accompanying drawings, and the thicknesses are exaggerated in the drawings to clearly represent several portions and regions.

Terms used in the specification is only provided to describe a specific embodiment of the present disclosure, and is not intended to limit the present disclosure. Terms of a single number used herein are intended to include its plural number unless the context clearly indicates otherwise.

It is to be understood that terms “comprise,” or “include” used in the specification specify the presence of features, numerals, steps, operations, elements and/or components, and do not preclude the presence or addition of one or more other features, numerals, steps, operations, components and/or groups thereof.

A term “coupled” used herein indicates a physical relationship between two components directly connected to each other, or indirectly connected to each other through one or more medium components.

In addition, an expression “operably connected” or a similar expression may indicate that at least two members are directly or indirectly connected to each other to thus transmit power. However, two members operably connected to each other may not be always rotated at the same speed and in the same direction.

Furthermore, a term used herein such as “vehicle,” “of a vehicle”, or “automobile,” or another similar term used in the specification generally includes a passenger automobile including a passenger vehicle, a sports utility vehicle (SUV), a bus, a truck, or various commercial vehicles. The automobile may include a hybrid automobile equipped with a high-voltage battery, an electric automobile, a hybrid electric automobile, an electric vehicle-based purpose built vehicle (PBV), or a hydrogen-powered vehicle (commonly referred to as a “hydrogen electric vehicle” by those having ordinary skill in the art).

When a component, controller, device, element, unit, module, apparatus, robot, system, or the like of the present disclosure is described as having a purpose or performing an operation, function, or the like, the component, controller, device, element, unit, module, apparatus, robot, system, or the like should be considered herein as being “configured to” meet that purpose or to perform that operation or function. Each component, controller, device, element, unit, module, apparatus, robot, system, and the like may separately embody or be included with a processor and a memory, such as a non-transitory computer readable media, as part of them.

Hereinbelow, the present disclosure is described in detail with reference to the accompanying drawings.

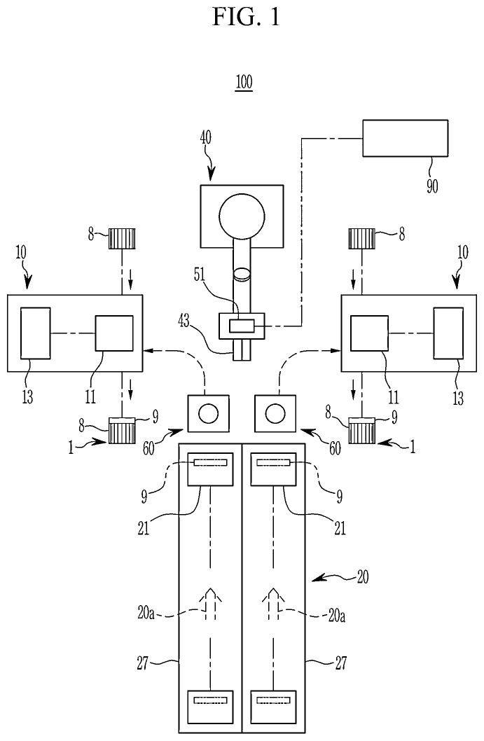

FIG. 1 is a block diagram schematically showing an automatic supply system of a terminal assembly for a hair pin type stator according to an embodiment of the present disclosure.

Referring to FIG. 1, an automatic supply system 100 of a terminal assembly for a hair pin type stator according to an embodiment of the present disclosure may be applied to a process of manufacturing a hair pin type stator 1.

The hair pin type stator 1 applied to an embodiment of the present disclosure may be applied to a drive motor for an eco-friendly automobile that acquires a drive force from electrical energy, for example, a hybrid vehicle or an electric automobile.

The drive motor may include the hair pin type stator 1 that is applied to an embodiment of the present disclosure, and a rotor (not shown in the drawing) disposed to have a certain gap from the hair pin type stator 1.

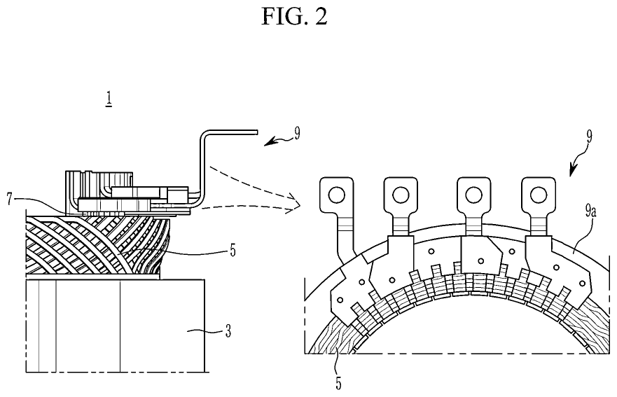

As shown in FIG. 2, the hair pin type stator 1 may include a stator core 3 in which a plurality of electrical steel sheets are stacked. The stator core 3 may have a cylindrical shape.

The stator core 3 may be wounded with a hair pin type stator coil 5 (also referred to as a conductor coil, a segment coil, or a square coil by those having ordinary skill in the art). The hair pin type stator coil 5 may have, for example, a V-shape, a U-shape, or an I-shape. These hair pin type stator coils 5 may be joined (e.g., welded) to each other and connected to each other in the form of an electrical circuit.

Furthermore, in an example, the hair pin type stator 1 may include a terminal assembly 9 connected to coil outlets 7 of four phases (U, V, W, and N phases) that is drawn from the stator coils 5 through a bus bar 9a.

In an example, the terminal assembly 9 may have a semicircular shape and may be connected to the coil outlets 7 by welding. The terminal assembly 9 may be disposed on top of the stator core 3. Furthermore, the terminal assembly 9 may have a different specification based on a model of the hair pin type stator 1.

The automatic supply system 100 of a terminal assembly for a hair pin type stator according to an embodiment of the present disclosure may be applied to a terminal welding process of welding the coil outlets 7 and the terminal assembly 9 to each other among manufacturing processes of the hair pin type stator 1.

The terminal welding process may provide a stator assembly 8 manufactured through a coil inserting process, a coil widening process, a coil twisting process, a coil cutting process, and a coil welding process. In addition, the terminal welding process may provide the terminal assembly 9 to be welded to the coil outlets 7 of the stator assembly 8.

The automatic supply system 100 of a terminal assembly for a hair pin type stator according to an embodiment of the present disclosure may supply the terminal assembly 9 to a welding jig 11 of a welding unit 10, which welds the stator assembly 8 and the terminal assembly 9 to each other in the terminal welding process.

The plurality of the welding units 10 may be provided to respectively weld the stator assemblies 8 of the different models and the terminal assemblies 9 of the different specifications to each other based on the model of the stator assembly 8. In an example, the welding units 10 may be disposed at two locations, as shown in the drawing.

In addition, the welding jig 11 of the welding unit 10 may regulate (e.g., clamp) the stator assembly 8 and the terminal assembly 9. The welding unit 10 may weld the stator assembly 8 and the terminal assembly 9, which are regulated by the welding jig 11, to each other by using a welding robot 13.

The automatic supply system 100 of a terminal assembly for a hair pin type stator according to an embodiment of the present disclosure may be configured to automatically supply the terminal assemblies 9 of the different specifications to the welding unit 10.

Referring to FIG. 1, the automatic supply system 100 of a terminal assembly for a hair pin type stator according to an embodiment of the present disclosure may include a conveyor unit 20, a terminal supply robot 40, and a terminal alignment unit 60.

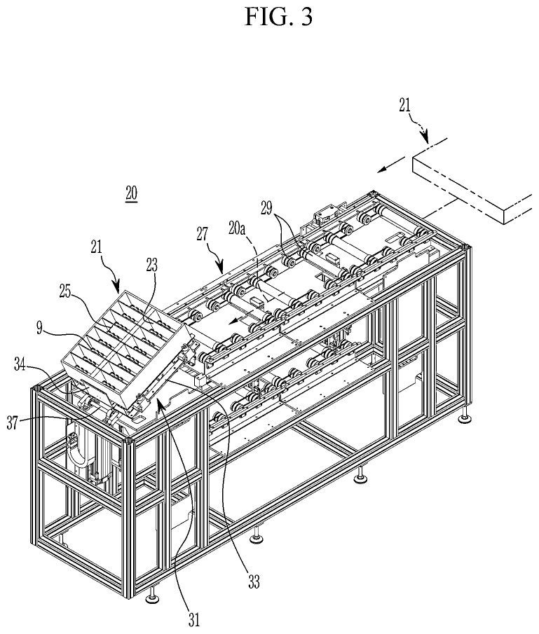

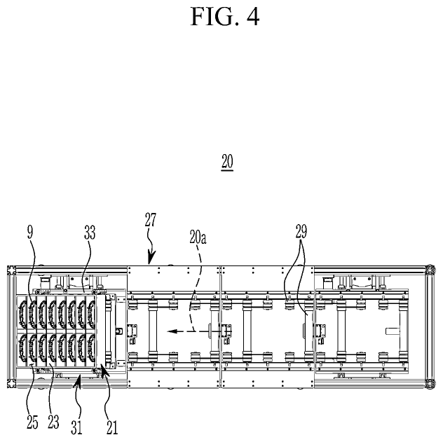

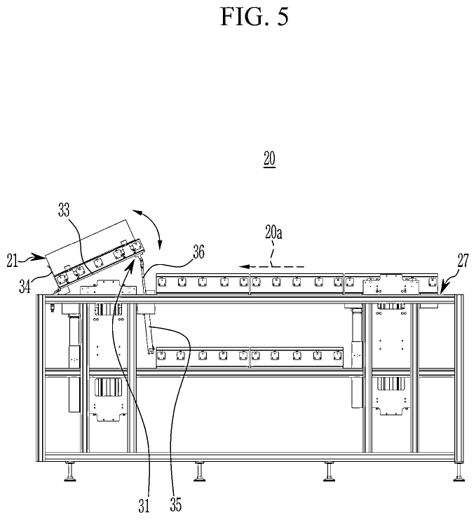

FIG. 3 is a perspective view showing the conveyor unit applied to the automatic supply system of a terminal assembly for a hair pin type stator according to an embodiment of the present disclosure; FIG. 4 is a plan view showing the conveyor unit applied to the automatic supply system of a terminal assembly for a hair pin type stator according to an embodiment of the present disclosure; and FIG. 5 is a side view showing the conveyor unit applied to the automatic supply system of a terminal assembly for a hair pin type stator according to an embodiment of the present disclosure.

Referring to FIGS. 3 to 5, in an embodiment of the present disclosure, the conveyor unit 20 may transport a terminal supply box 21 storing the plurality of the terminal assemblies 9 along a set transport path 20a.

The terminal supply box 21 may store the terminal assemblies 9 of set specifications. The terminal supply box 21 may store the terminal assemblies 9 in terminal storage sections 25 respectively partitioned by a plurality of partitions 23. The plurality of terminal supply boxes 21 may be provided and continuously transported along the transport path 20a.

The conveyor unit 20 according to an embodiment of the present disclosure may include at least one conveyor body 27 and a tilting module 31.

The at least one conveyor body 27 may be installed on a floor of a process workshop. The at least one conveyor body 27 may form the transport path 20a of the terminal supply box 21.

In an example, the conveyor bodies 27 may be disposed at two locations, as shown in the drawing.

One of the conveyor bodies 27 at two locations may transport the terminal supply box 21 storing the terminal assemblies 9 of one specification along the transport path 20a.

In addition, the other conveyor body 27 may transport the terminal supply box 21 storing the terminal assemblies 9 of the different specification along the transport path 20a.

The conveyor body 27 may include a plurality of conveyor rollers 29. The plurality of conveyor rollers 29 may be rotatably installed on the conveyor body 27 along the transport path 20a.

The plurality of conveyor rollers 29 may include a drive roller performing a drive rotation by a conveyor drive unit (not shown) and a driven roller performing a driven rotation (e.g., idle rotation) while being in contact with the terminal supply box 21.

The tilting module 31 may tilt the terminal supply box 21 transported to a set location (e.g., an end point of the transport path) along the transport path 20a of the conveyor body 27 in a vertical direction.

The tilting module 31 may tilt the terminal supply box 21 in the vertical direction, thereby correctly disposing the terminal assemblies 9 scattered in the terminal storage sections 25 of the terminal supply box 21 under the terminal storage sections 25 by gravity.

The tilting module 31 may be installed on the transport path 20a of each conveyor body 27. The tilting module 31 may include a tilting plate 33 and a tilt cylinder 35.

The tilting plate 33 may support the terminal supply box 21 transported along the transport path 20a. The tilting plate 33 may be installed at a location corresponding to the end of the transport path 20a to be able to be tilted and rotated with respect to the conveyor body 27 in the vertical direction. The tilting plate 33 may be tilted and rotated around a tilt rotation shaft 37 installed on the conveyor body 27 in the vertical direction.

The tilting plate 33 may include a stopper 34 stopping the terminal supply box 21 from slipping in transportation and tilting directions. The stopper 34 may have a plate form, and be disposed to be adjacent to a tilt rotation center of the tilting plate 33.

In addition, the tilt cylinder 35 may apply a tilt rotation operating force to the tilting plate 33. The tilt cylinder 35 may be fixed to the conveyor body 27 and operably connected to the tilting plate 33.

In an example, the tilt cylinder 35 may include a pneumatic cylinder. The tilt cylinder 35 may include an operation rod 36 operated forward or backward by a pneumatic pressure. The operation rod 36 may be connected (e.g., hinged) with the tilting plate 33.

Referring to FIG. 1, in an embodiment of the present disclosure, the terminal supply robot 40 may be installed on the floor of the process workshop.

In an example, the terminal supply robot 40 may be fixedly installed on the floor of the process workshop. In addition, in another example, the terminal supply robot 40 may be installed to be able to slide in a set direction by a rail assembly installed on the floor of the process workshop.

The terminal supply robot 40 may be controlled by a robot controller (not shown). The terminal supply robot 40 may receive a robot control signal from the robot controller and move or rotate an arm 41 in the set direction. The terminal supply robot 40 may include an articulated robot known to those having ordinary skill in the art that is robot-operated along a teaching path set within a work radius.

Furthermore, the terminal supply robot 40 according to an embodiment of the present disclosure may grip or ungrip (i.e., release) the terminal assemblies 9, and load or unload the terminal assemblies 9 at the set location.

In detail, the terminal supply robot 40 may unload the terminal assemblies 9 stored in the terminal supply box 21 tilted by the tilting plate 33 (see FIGS. 3 to 5).

The terminal supply robot 40 may load the terminal assemblies 9 unloaded from the terminal supply box 21 into the terminal alignment unit 60 described below.

The terminal supply robot 40 may unload the terminal assemblies 9 aligned by the terminal alignment unit 60 from the terminal alignment unit 60.

In addition, the terminal supply robot 40 may load the terminal assembly 9 into the welding jig 11 of the welding unit 10 mentioned above.

The terminal supply robot 40 may load the terminal assemblies 9 respectively into the plurality of welding jigs 11 of the welding units 10 that are disposed (e.g., at two locations) within an operation radius.

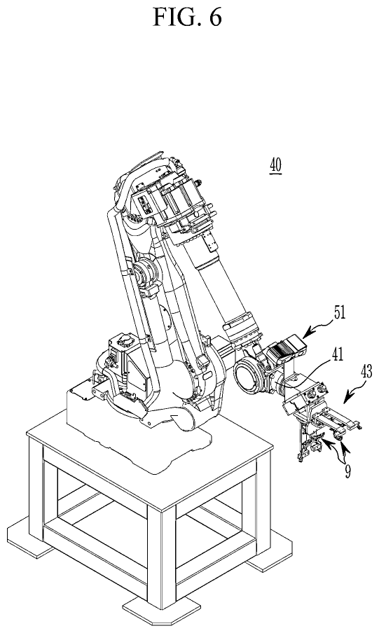

FIG. 6 is a perspective view showing the terminal supply robot applied to the automatic supply system of a terminal assembly for a hair pin type stator according to an embodiment of the present disclosure.

Referring to FIGS. 1 and 6, the terminal supply robot 40 according to an embodiment of the present disclosure as described above may include at least one gripper 43 and a vision sensor 51.

The at least one gripper 43 may grip or ungrip (i.e., release) the terminal assembly 9. The at least one gripper 43 may be mounted on a tip of the arm 41 through a mounting bracket 45.

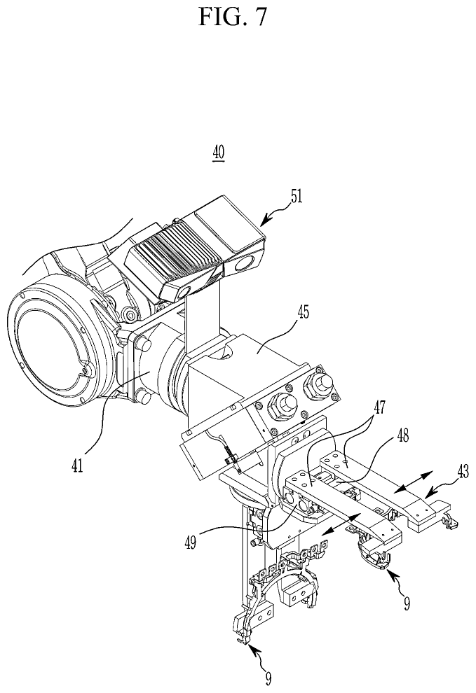

For example, the at least one gripper 43 may be mounted at each of two locations on the mounting bracket 45, as shown in FIG. 7.

The at least one gripper 43 may include a pair of fingers 47 coupled to a guide rail 48 installed on the mounting bracket 45. The pair of fingers 47 may be coupled to the guide rail 48 to perform a reciprocating slide movement to be further away from or closer to each other.

The pair of fingers 47 may perform the reciprocating slide movement along the guide rail 48 by an operation of a gripper cylinder 49 installed on the mounting bracket 45. In an example, the gripper cylinder 49 may include a pneumatic cylinder.

In addition, the vision sensor 51 may capture a vision of the terminal assembly 9 in the terminal supply box 21 tilted by the tilting plate 33 (see FIGS. 3 to 5). The vision sensor 51 may output vision data (e.g., image data) acquired by capturing the vision of the terminal assembly 9 to a controller 90 (hereinbelow, see FIG. 1).

The vision sensor 51 may be installed on the mounting bracket 45, as shown in FIGS. 6 and 7.

The controller 90 may acquire location information of the terminal assembly 9 by comparing the vision data received from the vision sensor 51 with set reference data.

Accordingly, the controller 90 may provide the control signal based on the location information of the terminal assembly 9 to the robot controller. The terminal supply robot 40 as described above may then change (e.g., correct) the teaching path within the work radius by the control signal received from the robot controller.

For this purpose, the controller 90 may be implemented as least one processor operated by a set program. In particular, the controller 90 may be implemented as at least one processor implementing an image recognition function known to those having ordinary skill in the art.

Referring to FIG. 1, in an embodiment of the present disclosure, the terminal alignment unit 60 may align the terminal assemblies 9 loaded at the set location by the terminal supply robot 40.

The reason for aligning the terminal assemblies 9 in this way is to load the terminal assemblies 9 in a set posture (e.g., a set direction, a set orientation, a set position, or any combination thereof) at the set location of the welding jig 11 of the welding unit 10 through the terminal supply robot 40.

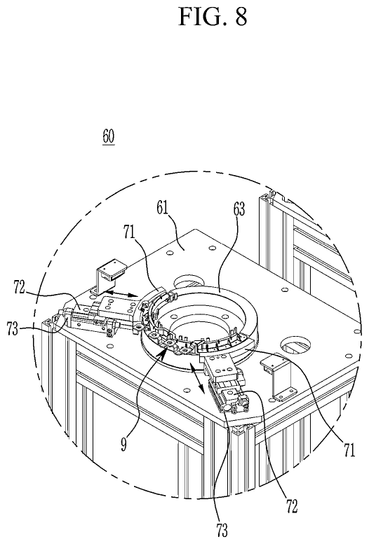

FIG. 8 is a perspective view showing the terminal alignment unit applied to the automatic supply system of a terminal assembly for a hair pin type stator according to an embodiment of the present disclosure.

Referring to FIGS. 1 and 8, the terminal alignment unit 60 according to an embodiment of the present disclosure may be installed on the floor of the process workshop at a location corresponding to the conveyor unit 20. In an example, the terminal alignment units 60 may be disposed at two locations, and respectively disposed at locations corresponding to two locations of the conveyor body 27.

The terminal alignment unit 60 may include a support frame 61, a terminal locator 63, a terminal alignment member 71, and an alignment cylinder 73.

The support frame 61 may be fixed to the floor of the process workshop. The terminal locator 63 may support the terminal assembly 9 loaded by the terminal supply robot 40 from its lower side.

The terminal locator 63 may be fixed onto the support frame 61. In an example, the terminal locator 63 may be provided as a ring-shaped block to support the terminal assembly 9 having the semicircular shape from its lower side.

The terminal alignment members 71 may support the terminal assembly 9 disposed on the terminal locator 63 from both sides of the terminal locator 63.

The terminal alignment members 71 may be installed on the support frame 61 to be able to be moved forward and backward from both the sides of the terminal locator 63 while having the terminal locator 63 therebetween.

In an example, the terminal alignment members 71 may be provided as arc-shaped blocks to support the terminal assembly 9 having the semicircular shape from both the sides of the terminal locator 63.

The terminal alignment member 71 may be slidably coupled to a guide rail 72 disposed on the support frame 61.

In addition, the alignment cylinder 73 may move the terminal alignment member 71 forward or backward along the guide rail 72.

The alignment cylinder 73 may be installed on the support frame 61 and operably connected to the terminal alignment member 71. In an example, the alignment cylinder 73 may include the pneumatic cylinder.

Hereinbelow, the description describes an operation of the automatic supply system 100 of a terminal assembly for a hair pin type stator according to an embodiment of the present disclosure configured as described above in detail with reference to FIGS. 1 to 8.

First, in an embodiment of the present disclosure, provided are the plurality of the terminal supply boxes 21 storing the terminal assemblies 9 in the respective terminal storage sections 25.

The terminal assemblies 9 of one specification may be stored in some of the plurality of terminal supply boxes 21, and the terminal assemblies 9 of the different specification may be stored in the other terminal supply boxes 21.

In this state, the terminal supply boxes 21 storing the terminal assemblies 9 of one specification may be loaded into one of the conveyor bodies 27 at two locations. In addition, the terminal supply boxes 21 storing the terminal assemblies 9 of the different specification may be loaded into the other conveyor body 27.

The terminal supply boxes 21 described above may then be continuously transported along the set transport path 20a of the conveyor body 27 by the plurality of conveyor rollers 29. The tilting plate 33 of the tilting module 31 may be moved downward by a backward operation of the tilt cylinder 35, and maintain a horizontal state on an extension line of the transport path 20a.

In this process, one of the terminal supply boxes 21 may be seated on an upper surface of the tilting plate 33. The stopper 34 may stop the transportation of the terminal supply box 21.

The tilting plate 33 may then be tilted and rotated upward around the tilt rotation shaft 37 due to a forward operation of the tilt cylinder 35. Accordingly, the terminal supply box 21 may be tilted in the vertical direction while being stopped by the stopper 34.

Therefore, the terminal assemblies 9 scattered in the terminal storage sections 25 of the terminal supply box 21 may be correctly disposed under the terminal storage sections 25 by gravity.

The gripper 43 of the terminal supply robot 40 may be disposed to be adjacent to the terminal supply box 21 tilted in the vertical direction.

Next, the vision sensor 51 of the terminal supply robot 40 may capture the vision of the terminal assembly 9 stored in the terminal storage section 25, and output the vision data to the controller 90.

Accordingly, the controller 90 may acquire the location information of the terminal assembly 9 by comparing the vision data received from the vision sensor 51 with the set reference data, and provide the control signal based on the location information to the robot controller.

The terminal supply robot 40 may then correct the teaching path within the work radius based on the control signal received from the robot controller, and move the gripper 43 to the set location.

Next, the gripper 43 may grip the terminal assembly 9 stored in the terminal storage section 25, and may be moved toward the terminal alignment unit 60 by the robot operation of the terminal supply robot 40 in this state.

The gripper 43 may then ungrip (i.e., release) the terminal assembly 9 from the terminal alignment unit 60, and load the terminal assembly 9 onto the terminal locator 63 of the terminal alignment unit 60.

Next, the terminal alignment members 71 may be moved forward from both the sides of the terminal locator 63 while having the terminal locator 63 therebetween by the operation of the alignment cylinder 73. Accordingly, the terminal alignment member 71 may push both the sides of the terminal assembly 9 and correctly disposed the terminal assembly 9 at the set location on the terminal locator 63.

The terminal alignment units 60 as described above may be disposed at two locations. Therefore, one alignment unit 60 may align the terminal assemblies 9 of one specification, and the other alignment unit 60 may align the terminal assemblies 9 of the different specification.

The terminal alignment member 71 may be moved backward by the operation of the alignment cylinder 73 in this state, and the gripper 43 may then grip the terminal assembly 9 on the terminal locator 63.

Next, the gripper 43 may be moved to the welding unit 10 by the robot operation of the terminal supply robot 40.

Next, the gripper 43 may ungrip (i.e., release) the terminal assembly 9, and load the terminal assembly 9 into the welding jig 11 of the welding unit 10. The stator assembly 8 with the coil outlets 7 may be loaded into the welding jig 11.

Furthermore, the terminal supply robot 40 may load the terminal assemblies 9 of one specification and the terminal assemblies 9 of the different specification respectively into the welding jig 11 of the welding unit 10 disposed at two locations within the operation radius through the gripper 43.

Accordingly, the coil outlets 7 of the stator assembly 8 and the terminal assembly 9 regulated by the welding jig 11 of the welding unit 10 may be welded to each other by the welding robot 13.

The automatic supply system 100 of a terminal assembly for a hair pin type stator according to an embodiment of the present disclosure as described hereinabove may supply the terminal assembly 9 to the welding unit 10 through a series of automated processes as described above.

Therefore, the automatic supply system 100 of a terminal assembly for a hair pin type stator according to an embodiment of the present disclosure may improve welding workability of the terminal assemblies 9, and reducing an excessive welding work time and the number of workers.

Furthermore, the automatic supply system 100 of a terminal assembly for a hair pin type stator according to an embodiment of the present disclosure may automatically supply the terminal assemblies 9 of the different specifications to the welding unit 10 based on the model of the hair pin type stator 1.

In this way, the automatic supply system 100 of a terminal assembly for a hair pin type stator according to an embodiment of the present disclosure may prevent the terminal assembly 9 of a specification not matching the model of the hair pin type stator 1 in advance from being supplied to the welding unit 10.

Although an embodiment of the present disclosure has been described hereinabove, the spirit of the present disclosure is not limited to an embodiment described in the specification. Those having ordinary skill in the art who understand the spirit of the present disclosure may easily suggest another embodiment by adding, changing, deleting, or supplementing a component within the scope of the same spirit, which also falls within the scope of the present disclosure.

### DESCRIPTION OF SYMBOLS

1: hair pin type stator 3: stator core
5: stator coil 7: coil outlet
8: stator assembly 9: terminal assembly
9a: bus bar 10: welding unit
11: welding jig 13: welding robot
20: conveyor unit 20a: transport path
21: terminal supply box 23: partition
25: terminal storage section 27: conveyor body
29: conveyor roller 31: tilting module
33: tilting plate 34: stopper
35: tilt cylinder 36: operation rod
37: tilt rotation shaft 40: terminal supply robot
41: arm 43: gripper
45: mounting bracket 47: finger
48, 72: guide rail 49: gripper cylinder
51: vision sensor 60: terminal alignment unit
61: support frame 63: terminal locator
71: terminal alignment member 73: alignment cylinder
90: controller
100: automatic supply system of a terminal assembly for a hair pin type stator

What is claimed is:

1. An automatic supply system of a terminal assembly for a stator to supply the terminal assembly to a welding unit welding a stator coil and the terminal assembly of the stator to each other, the system comprising:
a conveyor unit configured to transport a terminal supply box storing a plurality of terminal assemblies along a set transport path;
a terminal supply robot configured to grip or release at least one terminal assembly of the plurality of the terminal assemblies and load or unload the at least one terminal assembly at a set location; and
a terminal alignment unit configured to align the at least one terminal assembly loaded at the set location by the terminal supply robot.

2. The system of claim 1, wherein the terminal supply robot configured to:
unload the at least one terminal assembly stored in the terminal supply box and load the at least one terminal assembly into the terminal alignment unit; and
unload the at least one terminal assembly aligned by the terminal alignment unit from the terminal alignment unit and load the at least one terminal assembly into a welding jig of the welding unit.

3. The system of claim 2, wherein the terminal supply robot is configured to load the at least one terminal assembly into the plurality of welding jigs of the welding units that are disposed within an operation radius.

4. The system of claim 1, wherein the conveyor unit includes at least one conveyor body including a plurality of conveyor rollers rotatably installed along the set transport path.

5. The system of claim 4, wherein the conveyor unit further includes a tilting module installed on the set transport path of the conveyor body.

6. The system of claim 5, wherein the tilting module includes:
a tilting plate installed at a location corresponding to an end of the set transport path to be able to be tilted and rotated with respect to the conveyor body in a vertical direction, and
a tilt cylinder installed on the conveyor body and connected to the tilting plate.

7. The system of claim 6, wherein the tilting plate includes a stopper configured to stop the transportation of the terminal supply box.

8. The system of claim 1, wherein the terminal supply robot includes at least one gripper mounted on a tip of an arm through a mounting bracket.

9. The system of claim 8, wherein the terminal supply robot further includes a vision sensor installed on the mounting bracket and is configured to:
capture a vision of the at least one terminal assembly of the plurality of the terminal assemblies stored in the terminal supply box; and
output vision data to a controller.

10. The system of claim 9, wherein the controller is configured to acquire location information of the at least one terminal assembly by comparing the vision data with set reference data.

11. The system of claim 1, wherein the terminal alignment unit includes:
a support frame;
a terminal locator installed on the support frame to support the at least one terminal assembly;
terminal alignment members installed to be able to be moved forward and backward from both sides of the terminal locator while having the terminal locator therebetween; and
an alignment cylinder installed on the support frame and connected to the terminal alignment member.

12. The system of claim 11, wherein the terminal locator has a ring shape to support the at least one terminal assembly having a semicircular shape.

13. The system of claim 12, wherein the terminal alignment member has an arc shape to support the at least one terminal assembly.

14. The system of claim 1, wherein the terminal supply box includes terminal storage sections respectively partitioned by a plurality of partitions.
